(19) United States
(12) Patent Application Publication
(10) Pub. No.: US 2025/0326098 A1
(43) Pub. Date: Oct. 23, 2025

(54) AIRCRAFT PANEL REMOVAL TOOL AND WORK AID

(71) Applicant: Textron Innovations Inc., Providence, RI (US)

(72) Inventor: Brack Taylor Nall, Lewisville, TX (US)

(73) Assignee: Textron Innovations Inc., Providence, RI (US)

(21) Appl. No.: 18/643,237

(22) Filed: Apr. 23, 2024

(51) Int. Cl. B64C 1/12

(52) U.S. Cl. CPC B25B 27/14; B25B 7/02; B64C 1/20

(57) ABSTRACT

An aircraft panel removal tool and work aid is disclosed. The tool comprises an anchor attachment fitting. The attachment fitting includes a plurality of claws that are biased open and configured to engage an attachment point of an aircraft component anchor. The attachment fitting also includes a collar slidably disposed over and about the plurality of claws. The collar slides upward to enable the plurality of claws to open and be disposed around the attachment point of the aircraft component anchor. The collar then slides downward to engage the plurality of claws with the attachment point of the aircraft component anchor. The tool includes a handle secured to the attachment fitting and configured to enable removal and/or manipulation of the aircraft panel.

### BACKGROUND

Aircraft (interior) panels, such as rotorcraft (e.g., helicopter) floor panels that may cover the fuel cells are typically long and/or wide (e.g., 8.5 feet long and 3 feet wide), heavy (e.g., 54 pounds), and very difficult to lift off of the aircraft's floor beams or the like. The interior panels may be adhered to a seal between the floor panel and the floor beams or the like even after the fasteners holding them in place are removed (e.g., 170 screws, for an 8.5 foot by 3 foot panel). Also, these floor panels may be attached (e.g., “VELCROed”) to fuel cell fuel bags to help the bag hold its shape, further exacerbating removal. Typically, puddy knives, scrapers, screwdrivers, or the like have been used to free these aircraft floor panels. This process has resulted in damage to the floor panel and usually requires two or three mechanics and a considerable amount of time and effort. This process has also resulted in injuries including muscle and back strains, pinched and/or crushed fingers, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is directed to systems and methods that provide an aircraft panel removal tool and work aid. The tool comprises an anchor attachment fitting. The attachment fitting includes a plurality of claws that are biased open and configured to engage an attachment point of an aircraft component anchor, and a collar slidably disposed over and about the plurality of claws. The collar is configured to slide upward to enable biasing of the plurality of claws open to a degree sufficient so that the plurality of claws may be disposed around the attachment point of the aircraft component anchor. The collar is further configured to slide downward to engage the plurality of claws with the attachment point of the aircraft component anchor. The tool includes a handle secured to the attachment fitting and configured to enable application of force, via the attachment point of the aircraft component anchor, to an aircraft panel in which the aircraft component anchor is mounted. This allows for removal and/or manipulation of the aircraft panel.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Having thus described the invention in general terms, reference will now be made to the accompanying drawings, which are not necessarily drawn to scale, and wherein:

FIG. 1 is a partially fragmented view of an example aircraft, on which various embodiments of the aircraft (floor) panel removal tool and work aid may be utilized, according to some embodiments.

FIG. 2 is an exploded, fragmented perspective view of a portion of an aircraft floor and fuel cell arrangement, in which various embodiments of the aircraft panel removal tool and work aid may be utilized, according to some embodiments.

FIG. 3 is a perspective view of an embodiment of an aircraft component (seat) anchor with which various embodiments of the aircraft panel removal tool and work aid may be utilized for removal of an aircraft (floor) panel, according to some embodiments.

FIG. 4 is a perspective view of an example embodiment of the aircraft panel (e.g., floor) removal tool and work aid, with an aircraft component anchor attachment fitting collar withdrawn for attachment to an aircraft component anchor, according to some embodiments.

FIG. 5 is a perspective view of an example embodiment of the aircraft panel removal tool and work aid engaged with an example aircraft component anchor, for removal of an aircraft panel, according to some embodiments.

FIG. 6 is a partially fragmented perspective, generally cross-sectional, view of an embodiment of an example embodiment of the aircraft panel removal tool and work aid engaged with an aircraft component anchor for removal of an aircraft panel, according to some embodiments.

FIG. 7 is a bottom view of the example embodiment of the aircraft panel removal tool and work aid.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

That is, while this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. Also, any headings used herein are for organizational purposes only and are not intended to limit the scope of the description. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

For example, although embodiments of the systems and methods may be described below with reference to rotary wing aircraft (e.g., helicopters), embodiments of the systems and methods may be applicable to various types of aircraft, including not only rotary wing aircraft, but also tiltrotor aircraft, fixed wing aircraft, or any aircraft or vehicle using the style of seat anchor illustrated herein.

In the specification, reference may be made to the spatial relationships between various components and to the spatial orientation of various aspects of components as the devices are depicted in the attached drawings. However, as will be recognized by those skilled in the art after a complete reading of the application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

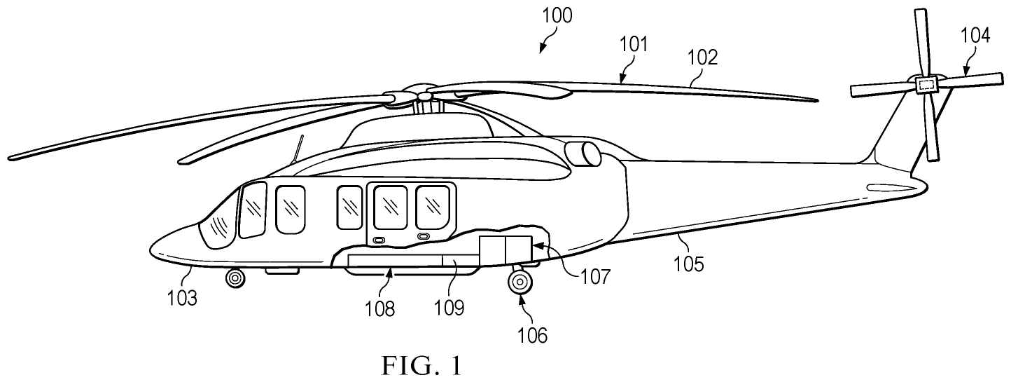

FIG. 1 is a partially fragmented view of an example aircraft, rotorcraft 100, on which various embodiments of the aircraft panel removal tool and work aid may be utilized. Rotorcraft 100 is schematically illustrated. Rotorcraft 100 has rotor system 101 with a plurality of rotor blades 102. The pitch of rotor blades 102 can be collectively and cyclically manipulated to selectively control direction, thrust, and lift of rotorcraft 100. Rotorcraft 100 includes a fuselage 103, an anti-torque system 104 and an empennage 105. Rotorcraft 100 has a landing gear system 106 to provide ground support for the aircraft. Located within a lower portion of fuselage 103, rotorcraft 100 includes a fuel tank receiving assembly 107 that supports and contains a fuel system 108 including a fuel cell 109. Fuel cell 109 may be a flexible bladder, or the like. A flexible fuel cell may be made of a flexible material or ballistic fabric, such as Kevlar® or other strong synthetic polymer. Liquid fuel is contained within fuel cell 109 that is used to power one or more engines that drive rotor system 101 and anti-torque system 104.

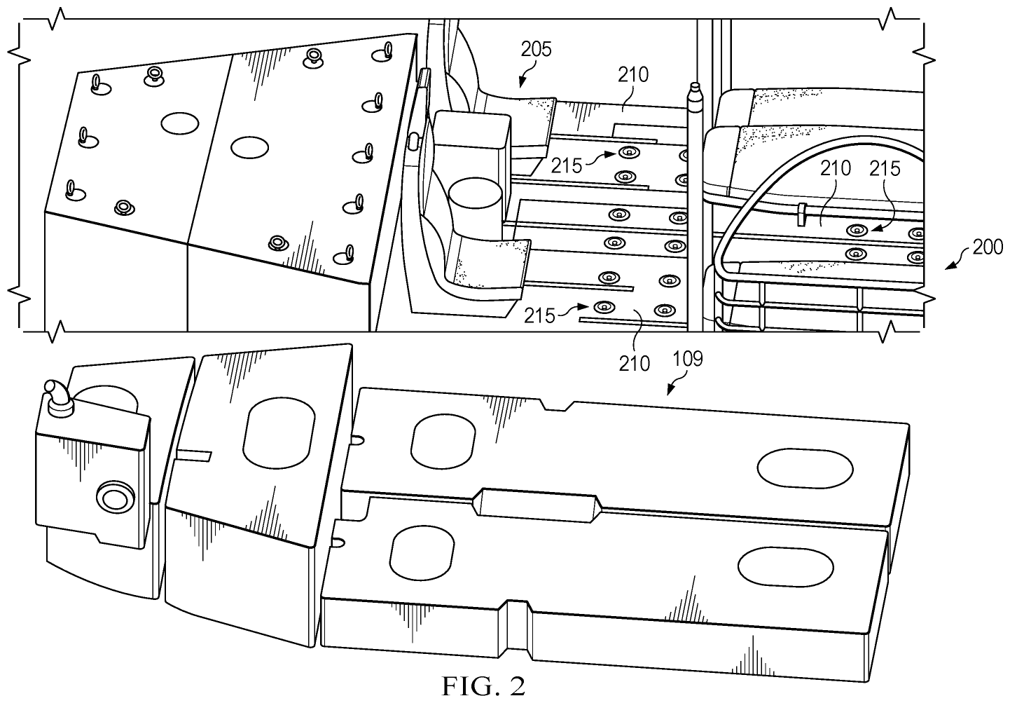

FIG. 2 is a fragmented perspective view of a portion of aircraft seat and fuel cell arrangement 200, in which various embodiments of the aircraft panel removal tool and work aid may be utilized according to some embodiments. As shown therein, seats 205 may be mounted on aircraft floor panels 210, such as via aircraft component (seat) anchors 215. As also shown, fuel cells 109 may be disposed below seats 205. As noted above, aircraft floor panels 210 may be attached (e.g., “VELCROed”) to fuel cell fuel bags to help the bag hold its shape. Aircraft floor panels 210, as illustrated, are long and/or wide (e.g., 8.5 feet long and 3 feet wide) and hence heavy (e.g., approximately 54 pounds). Also, aircraft floor panels 210 may be adhered to a seal between the floor panel and the floor beams (e.g., between fuel cells 109) and around the periphery (of fuel cells 109) or the like. Aircraft floor panels 210 may also be held in place by fasteners (e.g., an example rotorcraft requires 170 screws for an 8.5 foot by 3 foot panel). The type of screw used to fasten the floor panels will vary depending on the aircraft.

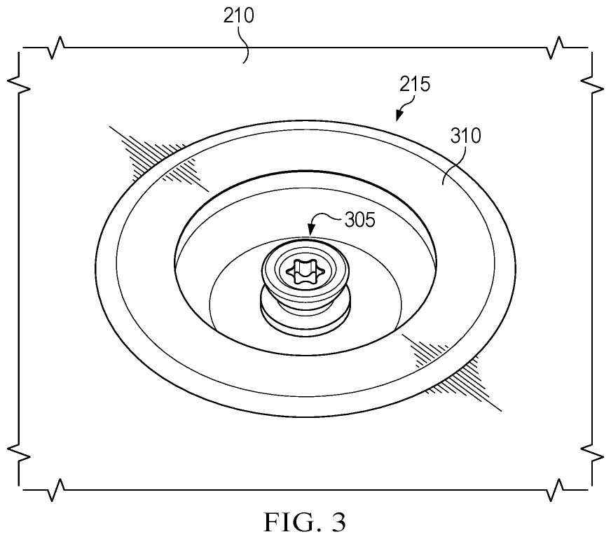

FIG. 3 is a perspective view of one embodiment of an aircraft component anchor 215 (e.g., a seat anchor) with which various embodiments of the aircraft panel removal tool and work aid may be utilized for removal of an aircraft panel (e.g., a floor panel) according to some embodiments. In the illustrated embodiment, aircraft seat anchor 215 is installed in aircraft floor panel 210, such as the floor panel of a rotorcraft 100. In some embodiments, aircraft floor panel 210 may comprise a composite core, such as a honeycomb or foam core. In other embodiments, however, any suitable type of aircraft floor panel 210 may be used.

In the illustrated embodiment, aircraft seat anchor 215 includes an attachment point 305. Attachment point 305 may be used as a mounting or attachment point for components attached to the aircraft floor panel 210 in which the aircraft seat anchor 215 is embedded. For example, aircraft seats or other fixtures may be attached to floor panel 210 using seat anchor 215. Such a fixture may include a corresponding attachment fitting, such as a claw-based attachment fitting, that can be mechanically clamped down on attachment point 305 of aircraft seat anchor 215. Thus, a fixture may be installed by clamping down its attachment fitting(s) to attachment point(s) 305 of one or more aircraft seat anchors 215. Fixtures can similarly be removed by disconnecting the fixture attachments points from the corresponding attachment points 305 of seat anchors 215. In this manner, the configuration of fixtures (e.g., seating configurations) can be relatively easily modified, for example, by adding, removing, and/or rearranging certain fixtures as desired.

In some embodiments, for example, attachment point 305 of aircraft seat anchor 215 may include a stud fastened to aircraft seat anchor 215 using mechanical fasteners (e.g., a locking nut and washers), and the stud of aircraft seat anchor 215 may interface with a corresponding attachment point of a particular fixture (e.g., a seat or payload fitting). Moreover, in some embodiments, aircraft seat anchor 215 may include multiple attachment points 305. In the illustrated embodiment, aircraft seat anchor 215 also includes flanges, such as illustrated top flange 310 and a corresponding flange on the other side of floor panel 210. In some embodiments, for example, aircraft seat anchor 215 may be formed from two adjacent such flanges.

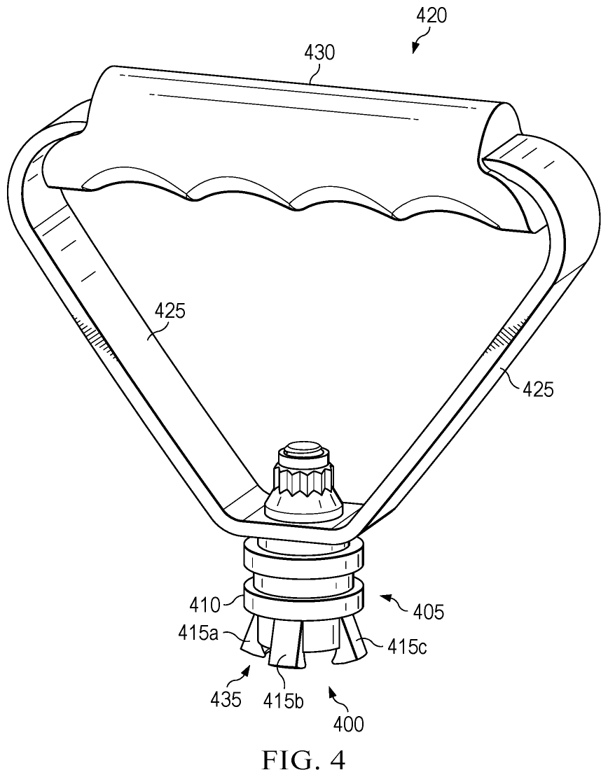

FIG. 4 is a perspective view of an example embodiment of an aircraft panel removal tool and work aid 400. As illustrated in FIG. 4, an aircraft component anchor attachment fitting 405 collar 410 withdrawn for attachment to an aircraft component (seat) anchor 215 according to some embodiments.

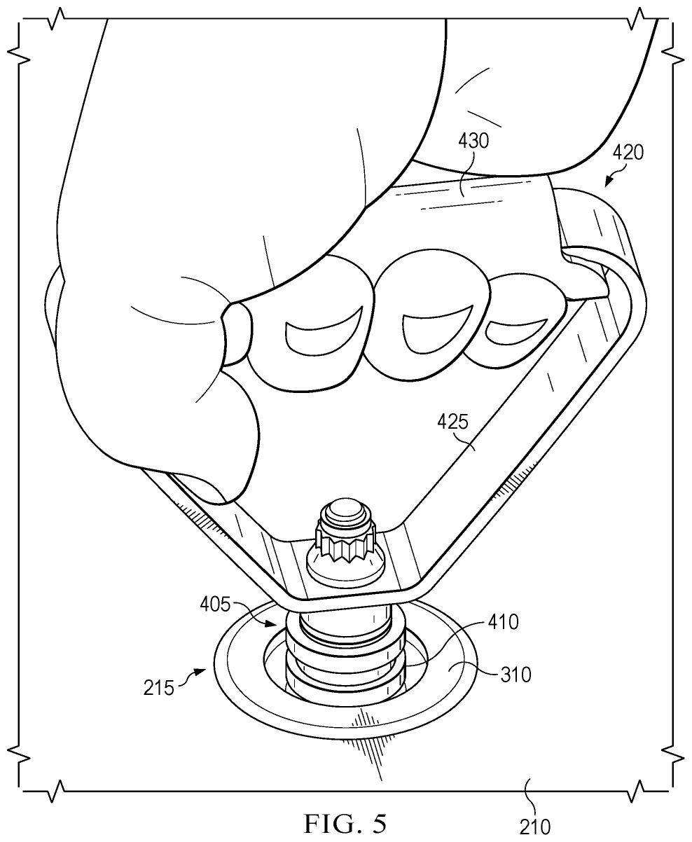

FIG. 5 is a perspective view of example embodiment of aircraft panel removal tool and work aid 400 engaged with an example aircraft component anchor 215 for removal of aircraft panel 210.

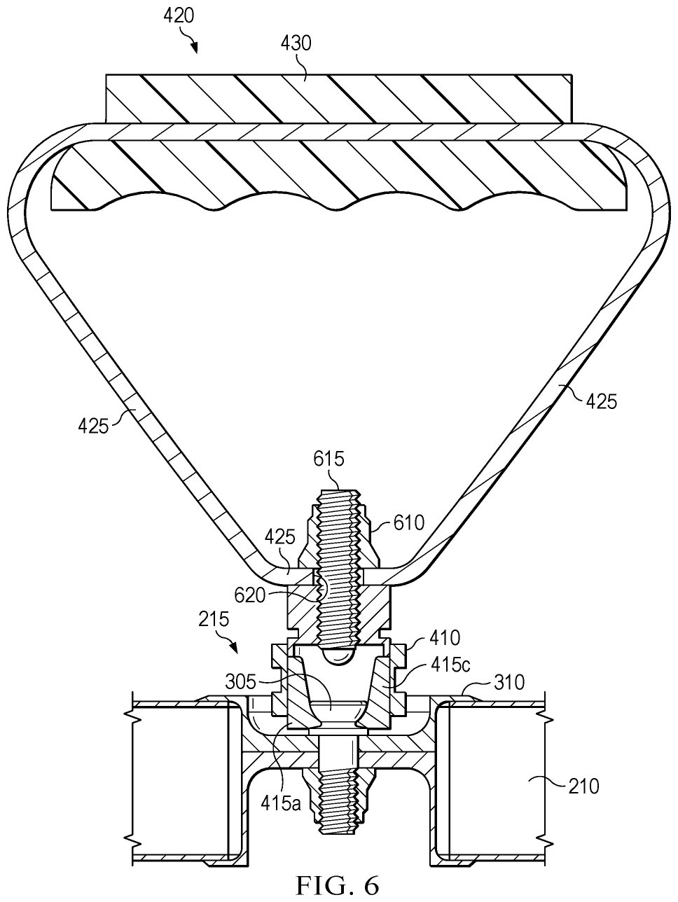

FIG. 6 is a partially fragmented, generally cross-sectional view of an example embodiment of the aircraft panel removal tool and work aid 400 engaged with example aircraft seat anchor 215 for removal of an aircraft panel 210 according to some embodiments.

As noted, panel removal tool and work aid 400 attaches to existing aircraft component anchors 215 in aircraft panels 210, such as passenger seat anchors on interior floor panels. Tool 400 works on any aircraft manufactured with this type of component anchor in the panels. As also noted, FIG. 4 shows aircraft panel removal tool and work aid 400 with fitting collar 410 withdrawn (i.e., slid “upward”), which results in (spring) biased fitting claws 415a-d spreading as shown for attachment to aircraft anchor attachment point 305. (Claw 415d not shown in the illustrated view.) FIG. 4 also shows handle 420 secured to attachment fitting 405, such as by struts 425 extending from hand grip 430 to aircraft component anchor attachment fitting 405. Struts 425 are sized, shaped, and positioned to dispose hand grip 430 generally parallel with the aircraft panel when claws 415a-d are engaged with attachment point 305 of aircraft component anchor 215. Hand grip facilitates (accurate and effective) application of force to an aircraft panel via the attachment point of the aircraft component anchor for removal and/or manipulation of the aircraft panel. FIG. 5 shows the resulting engagement of aircraft panel removal tool and work aid 400 with example aircraft component (seat) anchor 215 for removal of aircraft (floor) panel 210. Once claws 415a-d are disposed about seat anchor attachment point 305 and collar 410 slid down to engage fitting claws 415a-d with (i.e., about/around, in contact with) aircraft seat anchor attachment point 305.

FIG. 6 is a partially fragmented, generally cross-sectional view of an example embodiment of aircraft floor removal tool and work aid 400 engaged with example aircraft component (seat) anchor 215 for removal of an aircraft (floor) panel 210 according to some embodiments. Therein, aircraft panel removal tool and work aid 400 includes aircraft component anchor attachment fitting 405. The fitting 405 includes a plurality of claws 415a-d. Claws 415a-d are biased open to configure tool 400 for engagement with an attachment point 305 of an aircraft component anchor 215 in an aircraft panel 210. Claws 415a-d may be biased open using a spring or similar device. Anchor attachment fitting 405 includes collar 410, which is slidably disposed over and about (i.e., around) claws 415a-d.

Collar 410 slides “upward” (i.e., away from (distal) end 435 of tool 400) as shown in FIG. 4 to enable biasing of claws 415a-d open. Claws 415a-d are opened a sufficient amount to enable the claws 415a-d to be disposed around attachment point 305 of aircraft component anchor 215. When open, due to their (spring) bias, claws 415a-d pivot outward at distal end 435 of tool 400 from attachment fitting body 405 as shown in FIG. 4.

Correspondingly, collar 410 slides “downward” (i.e., toward (distal) end 435 of tool 400) as shown in FIGS. 5 and 6 to engage the plurality of claws 415a-d with attachment point 305 of the aircraft component anchor 215, as particularly shown in FIG. 6. When closed by collar 410, claws 415a-d pivot inward such that exterior surfaces of the claws 415a-d and attachment fitting body 405 are generally aligned as shown in FIG. 6. The plurality of claws 415a-d are configured to function together to engage attachment point 305 of aircraft component anchor 215 by being sized and shaped to engage attachment point 305. Some embodiments may employ a different number of claws, such as three or five or more claws each sized and shaped to engage the attachment point of the aircraft component anchor attachment fitting.

Aircraft panel removal tool and work aid handle 430 is secured to attachment fitting 405. For example, (lock) nut 610 or the like may secure handle strut 425 to attachment fitting stud 615. Stud 615 may extend from attachment fitting body 405 through handle strut attachment opening 620.

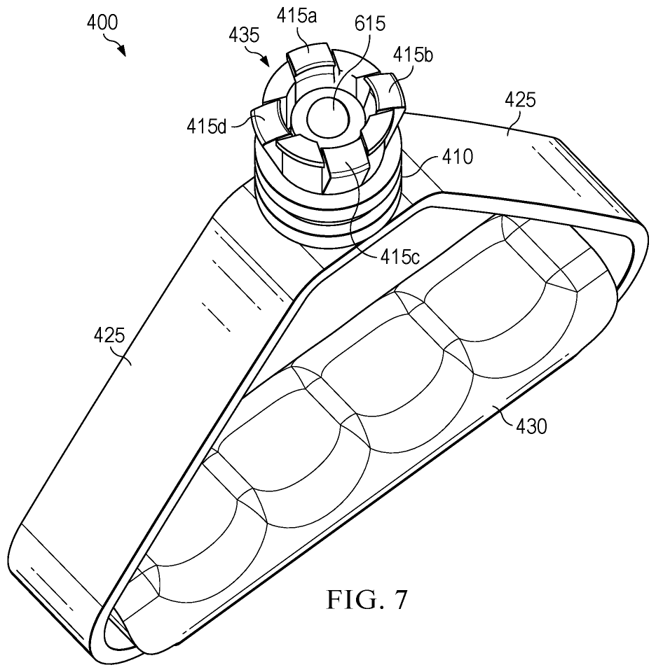

FIG. 7 is a bottom view of the example embodiment of the aircraft panel removal tool and work aid 400. As shown in FIG. 7, when collar 410 is moved “upward” (i.e., away from distal end 435 of tool 400) claws 415a-d are opened or spread apart, which allows for engagement of an attachment point 305 of aircraft seat anchor 215 or a fastener having a similar shape.

Thus, a process for aircraft panel removal and/or manipulation may include sliding a collar of such an aircraft panel removal tool and work aid to enable biasing of a plurality of claws in a distal end of the aircraft panel removal tool and work aid open, disposing the resultingly open plurality of claws of the aircraft panel removal tool and work aid around an attachment point of an aircraft component anchor disposed in an aircraft panel to be removed and/or manipulated and sliding the collar of the aircraft panel removal tool over the plurality of claws, engaging the attachment point of the aircraft component anchor with the aircraft panel removal tool and work aid. Thereafter, the aircraft panel may be removed, and/or otherwise manipulated, using the handle of the aircraft panel removal tool and work aid secured to the attachment fitting, via the attachment point of the aircraft component anchor. However, when removing an installed aircraft panel fasteners securing the aircraft panel should be removed, prior to engaging the attachment point of the aircraft component anchor with the aircraft panel removal tool and work aid.

A resulting aircraft panel system may include an aircraft panel that has at least one aircraft component anchor comprising at least one attachment point mounted therein and such an aircraft panel work aid for manipulating the panel into place, for installation, subsequently removing the panel and moving it out of the aircraft, and replacing the panel back into the aircraft.

In light of the foregoing, the aircraft panel removal tool and work aid enables a single person to lift a corner of a floor panel, which will release it from the floor beam seal and the VELCRO on the fuel tank bag/bladder, quickly, without causing any panel damage or personal injury. As a result, time is saved by lifting the floor panel in a few seconds instead of the typical twenty to thirty minutes. The process is efficient, allowing the removal of the floor panel with fewer mechanics and this ease of floor removal eliminates injuries to mechanics and damage to the aircraft.

In one embodiment, an aircraft panel removal tool and work aid comprises an aircraft-component-anchor attachment fitting. The attachment fitting comprises a plurality of claws. The claws are biased open and are configured to engage an attachment point of an aircraft component anchor. A collar is slidably disposed over and about the plurality of claws. The collar is configured to slide upward to enable biasing of the plurality of claws in a biased-open position that is sufficient to enable the plurality of claws to be disposed around the attachment point of the aircraft component anchor. The collar further configured to slide downward to engage the plurality of claws with the attachment point of the aircraft component anchor. The claws are forced to a closed position when the collar is moved downward, which causes the claws to engage or hook onto the attachment point. The tool has a handle that is secured to the attachment fitting. The handle enables a user to apply force to an aircraft panel via the attachment point, which is part of the aircraft component anchor that is mounted in the aircraft panel. The handle allows for removal and/or manipulation of the aircraft panel.

The plurality of claws may be sized and shaped to engage the attachment point of the aircraft component anchor attachment fitting. The plurality of claws comprise at least four claws, wherein each claw is sized and shaped to engage the attachment point of the aircraft component anchor attachment fitting.

The handle may comprises a grip that is configured to enable the application of force, via the attachment point of the aircraft component anchor, to the aircraft panel, for removal and or manipulation of the aircraft panel. The grip may be a hand grip disposed generally parallel with the aircraft panel when the plurality of claws are engaged with the attachment point of the aircraft component anchor.

The handle may comprises a hand grip and at least one strut extending from the hand grip to the aircraft component anchor attachment fitting. The at least one strut is sized, shaped, and positioned to dispose the hand grip generally parallel with the aircraft panel when the plurality of claws are engaged with the attachment point of the aircraft component anchor.

The aircraft panel may be an aircraft floor panel, and the aircraft component may be an aircraft seat.

In another embodiment, a method for aircraft panel removal and/or manipulation comprises sliding a collar of an aircraft panel removal tool upward, which enables biasing of a plurality of claws in a distal end of the aircraft panel removal tool to an open position. The method further includes placing or disposing the open plurality of claws of the aircraft panel removal tool around an attachment point of an aircraft component anchor, where the aircraft component anchor is disposed in an aircraft panel that is to be removed and/or manipulated. The method further include sliding the collar of the aircraft panel removal tool downward over the plurality of claws, thereby causing the claws to engage the attachment point of the aircraft component anchor. The method also includes removing and/or manipulating the aircraft panel using a handle of the aircraft panel removal tool, wherein the tool is secured to the attachment fitting via the attachment point of the aircraft component anchor.

The method for aircraft panel removal and/or manipulation may further include removal of the aircraft panel. The method comprises removing fasteners securing the aircraft panel, prior to engaging the attachment point of the aircraft component anchor with the aircraft panel removal tool.

The plurality of claws may be configured to engage the attachment point of the aircraft component anchor by being sized and shaped to engage the attachment point of the aircraft component anchor attachment fitting.

The plurality of claws may comprise at least four claws each sized and shaped to engage the attachment point of the aircraft component anchor attachment fitting.

The handle may include a grip configured to enable the application of force, via the attachment point of the aircraft component anchor, to the aircraft panel, where the force aids in removal and or manipulation of the aircraft panel. The grip may be a hand grip disposed generally parallel with the aircraft panel when the plurality of claws are engaged with the attachment point of the aircraft component anchor.

An aircraft panel system comprises an aircraft panel that includes at least one aircraft component anchor mounted therein. The aircraft component anchor may be a seat anchor, for example. Each aircraft component anchor comprises at least one attachment point. The system includes an aircraft panel work aid. The work aid comprises an aircraft component anchor attachment fitting. The attachment fitting comprises a plurality of claws that are biased open and are configured to engage an attachment point of an aircraft component anchor. The attachment fitting further comprises a collar slidably disposed over and about the plurality of claws. The collar is configured to slide upward to enable biasing of the plurality of claws to an open position sufficient to enable the plurality of claws to be disposed around the attachment point of the aircraft component anchor. The collar further configured to slide downward thereby causing engagement of the plurality of claws with the attachment point of the aircraft component anchor. The work aid further includes a handle secured to the attachment fitting and configured to enable application of force to an aircraft panel via the attachment point of the aircraft component anchor, where the aircraft component anchor is mounted in the aircraft panel and the application of force is for removal and/or manipulation of the aircraft panel.

The plurality of claws may be configured to engage the attachment point of the aircraft component anchor by being sized and shaped to engage the attachment point of the aircraft component anchor attachment fitting.

The plurality of claws may comprise at least four claws that are each sized and shaped to engage the attachment point of the aircraft component anchor attachment fitting.

The handle may comprises a grip that is configured to enable the application of force, via the attachment point of the aircraft component anchor, to the aircraft panel, which allows for removal and or manipulation of the aircraft panel by a user of the work aid. The grip may be a hand grip that is disposed generally parallel with the aircraft panel when the plurality of claws are engaged with the attachment point of the aircraft component anchor.

The handle may comprises a hand grip and at least one strut extending from the hand grip to the aircraft component anchor attachment fitting. The at least one strut may be sized, shaped, and positioned to dispose the hand grip generally parallel with the aircraft panel when the plurality of claws are engaged with the attachment point of the aircraft component anchor.

The aircraft panel may be an aircraft floor panel and the aircraft component is an aircraft seat.

The foregoing has outlined rather broadly the features and technical advantages of the invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the invention.

What is claimed is:

1. An aircraft panel removal tool and work aid comprising:
an aircraft component anchor attachment fitting, the attachment fitting comprising:
a plurality of claws, biased open and configured to engage an attachment point of an aircraft component anchor; and
a collar slidably disposed over and about the plurality of claws configured to:
slide upward to enable biasing of the plurality of claws biased open sufficient to enable the plurality of claws to be disposed around the attachment point of the aircraft component anchor; and
slide downward engaging the plurality of claws with the attachment point of the aircraft component anchor; and
a handle secured to the attachment fitting and configured to enable application of force, via the attachment point of the aircraft component anchor, to an aircraft panel, in which the aircraft component anchor is mounted, for removal and/or manipulation of the aircraft panel.

2. The aircraft panel removal tool and work aid of claim 1, wherein the plurality of claws are configured to engage the attachment point of the aircraft component anchor by being sized and shaped to engage the attachment point of the aircraft component anchor attachment fitting.

3. The aircraft panel removal tool and work aid of claim 1, wherein the plurality of claws comprise at least four claws each sized and shaped to engage the attachment point of the aircraft component anchor attachment fitting.

4. The aircraft panel removal tool and work aid of claim 1, wherein the handle comprises a grip configured to enable the application of force, via the attachment point of the aircraft component anchor, to the aircraft panel, for removal and or manipulation of the aircraft panel.

5. The aircraft panel removal tool and work aid of claim 4, wherein the grip is a hand grip disposed generally parallel with the aircraft panel when the plurality of claws are engaged with the attachment point of the aircraft component anchor.

6. The aircraft panel removal tool and work aid of claim 1, wherein the handle comprises a hand grip and at least one strut extending from the hand grip to the aircraft component anchor attachment fitting, the at least one strut sized, shaped, and positioned to dispose the hand grip generally parallel with the aircraft panel when the plurality of claws are engaged with the attachment point of the aircraft component anchor.

7. The aircraft panel removal tool and work aid of claim 1, wherein the aircraft panel is an aircraft floor panel and the aircraft component is an aircraft seat.

8. A method for aircraft panel removal and/or manipulation comprising:
sliding a collar of an aircraft panel removal tool and work aid to enable biasing of a plurality of claws in a distal end of the aircraft panel removal tool and work aid open;
disposing the resultingly open plurality of claws of the aircraft panel removal tool and work aid around an attachment point of an aircraft component anchor disposed in an aircraft panel to be removed and/or manipulated;
sliding the collar of the aircraft panel removal tool over the plurality of claws, engaging the attachment point of the aircraft component anchor with the aircraft panel removal tool and work aid; and
removing and/or manipulating the aircraft panel using a handle of the aircraft panel removal tool and work aid secured to the attachment fitting, via the attachment point of the aircraft component anchor.

9. The method of claim 8, wherein the method for aircraft panel removal and/or manipulation comprises removal of the aircraft panel and the method further comprises removing fasteners securing the aircraft panel, prior to engaging the attachment point of the aircraft component anchor with the aircraft panel removal tool and work aid.

10. The method of claim 8, wherein the plurality of claws are configured to engage the attachment point of the aircraft component anchor by being sized and shaped to engage the attachment point of the aircraft component anchor attachment fitting.

11. The method of claim 8, wherein the plurality of claws comprise at least four claws each sized and shaped to engage the attachment point of the aircraft component anchor attachment fitting.

12. The method of claim 8, wherein the handle comprises a grip configured to enable the application of force, via the attachment point of the aircraft component anchor, to the aircraft panel, for removal and or manipulation of the aircraft panel.

13. The method of claim 12, wherein the grip is a hand grip disposed generally parallel with the aircraft panel when the plurality of claws are engaged with the attachment point of the aircraft component anchor.

14. An aircraft panel system comprising:
an aircraft panel that includes at least one aircraft component anchor mounted therein, each aircraft component anchor comprising at least one attachment point; and
an aircraft panel work aid comprising:
an aircraft component anchor attachment fitting, the attachment fitting comprising:
a plurality of claws, biased open and configured to engage an attachment point of an aircraft component anchor; and
a collar slidably disposed over and about the plurality of claws configured to:
slide upward to enable biasing of the plurality of claws biased open sufficient to enable the plurality of claws to be disposed around the attachment point of the aircraft component anchor; and slide downward engaging the plurality of claws with the attachment point of the aircraft component anchor; and
a handle secured to the attachment fitting and configured to enable application of force, via the attachment point of the aircraft component anchor, to an aircraft panel, in which the aircraft component anchor is mounted, for removal and/or manipulation of the aircraft panel.

15. The aircraft panel system of claim 14, wherein, in the aircraft panel work aid, the plurality of claws are configured to engage the attachment point of the aircraft component anchor by being sized and shaped to engage the attachment point of the aircraft component anchor attachment fitting.

16. The aircraft panel system of claim 14, wherein, in the aircraft panel work aid, the plurality of claws comprise at least four claws each sized and shaped to engage the attachment point of the aircraft component anchor attachment fitting.

17. The aircraft panel system of claim 14, wherein, in the aircraft panel work aid, the handle comprises a grip configured to enable the application of force, via the attachment point of the aircraft component anchor, to the aircraft panel, for removal and or manipulation of the aircraft panel.

18. The aircraft panel system of claim 17, wherein, in the aircraft panel work aid, the grip is a hand grip disposed generally parallel with the aircraft panel when the plurality of claws are engaged with the attachment point of the aircraft component anchor.

19. The aircraft panel system of claim 14, wherein, in the aircraft panel work aid, the handle comprises a hand grip and at least one strut extending from the hand grip to the aircraft component anchor attachment fitting, the at least one strut sized, shaped, and positioned to dispose the hand grip generally parallel with the aircraft panel when the plurality of claws are engaged with the attachment point of the aircraft component anchor.

20. The aircraft panel system of claim 14, wherein, in the aircraft panel work aid, the aircraft panel is an aircraft floor panel and the aircraft component is an aircraft seat.
